(19) United States
(12) Patent Application Publication
(10) Pub. No.: US 2017/0193583 A1
(43) Pub. Date: Jul. 6, 2017

(54) AUTOMATED PRODUCT INFORMATION RETRIEVAL

(71) Applicant: PayPal Inc., San Jose, CA (US)

(72) Inventors: Sandra Lynn Godsey, San Jose, CA (US); Michael Charles Todasco, Santa Clara, CA (US)

(21) Appl. No.: 14/986,311

(22) Filed: Dec. 31, 2015

(51) Int. Cl. G06Q 30/06; G06F 17/30

(52) U.S. Cl. CPC G06Q 30/0627; G06F 17/30424; G06F 17/30864; G06Q 30/0629; G06Q 30/0641

(57) ABSTRACT

A computer-implemented method may include parsing, at a first device, source code of a first webpage of a first web site and obtaining, from the source code, an identifier of and a first value of a characteristic of a product on the first webpage. The method may also include directing transmission of the identifier, characteristic, and first value to a second device and directing a search of a database for the identifier with respect to the characteristic to obtain a second value of the characteristic of the product that is included on a second webpage of a second website. The method may further include comparing the second value and the first value, directing transmission of an indication of the second value from the second device to a third device, and presenting, by way of the third device, a notification concerning the second value of the characteristic of the product.

### FIELD

The embodiments discussed herein are related to the automated retrieval of product information.

### BACKGROUND

Through the expansion of the internet, information, merchandise, and services, from a variety of suppliers are available anywhere in the world. For example, previously buyers were limited to purchasing products in nearby stores or from available catalogs provided through mail. Currently, buyers may search for products on-line. An on-line search may result in the presentation of products from multiple buyers. The total prices, such as a price with tax, shipping, and the sale of the product may vary dramatically, making the purchasing decision difficult for a buyer. Alternately, a buyer may find a product from a supplier and may not be able to determine if the price of the product from the supplier is competitive without spending time searching competitive websites.

The subject matter claimed herein is not limited to embodiments that solve any disadvantages or that operate only in environments such as those described above. Rather, this background is only provided to illustrate one example technology area where some embodiments described herein may be practiced.

### BRIEF DESCRIPTION OF THE DRAWINGS

Example embodiments will be described and explained with additional specificity and detail through the use of the accompanying drawings in which:

FIG. 1 illustrates an example system that may be used for automated retrieval of product information;

FIG. 2 illustrates another example system that may be used for automated retrieval of product information;

FIG. 3 illustrates an example device that may be used in a system for automated retrieval of product information;

FIG. 4 is a flowchart of an example computer-implemented method of automated product information retrieval; and

FIG. 5 is a flowchart of another example computer-implemented method of automated product information retrieval.

### DESCRIPTION OF EMBODIMENTS

Some embodiments herein relate to systems and/or methods of automated product information retrieval. For example, a user may navigate to a first webpage on a first device using a web browser. The first webpage may present a product, such as merchandise or services, for sale to the user. A software program operating on the first device, such as a plug-in for the web browser, may parse the code of the first webpage. By parsing the code, the software program may obtain an identifier of the product, such as a SKU number. The software program may also obtain a characteristic of the product. The characteristic may be a price, shipping price, total price, shipping options and/or prices, whether the product is “green,” i.e., manufactured in an environmentally friendly way and/or including environmentally friendly materials.

The software program may provide the identifier and the characteristic of the product to a second device. The second device may be a server that is part of another system. The second device may direct the performance of a search of the internet or a database to determine whether the product is offered by a different website. When the product is offered by a different web site, the second device may compare a first value of the characteristic of the product from the first device with a second value of the characteristic of the product obtained from the second website. When the second device determines that the second value would be preferred by the user over the first value, the second device may transmit an indication of the second value to a user device associated with the user. As a result, a notification may be provided to the user from the user device about the second value of the product from the second website. The user device may be the first device or a third device. The user, being notified of the availability of the product from the second website, may then purchase the product from either website. Thus, the system and method herein provides for automated retrieval of product information.

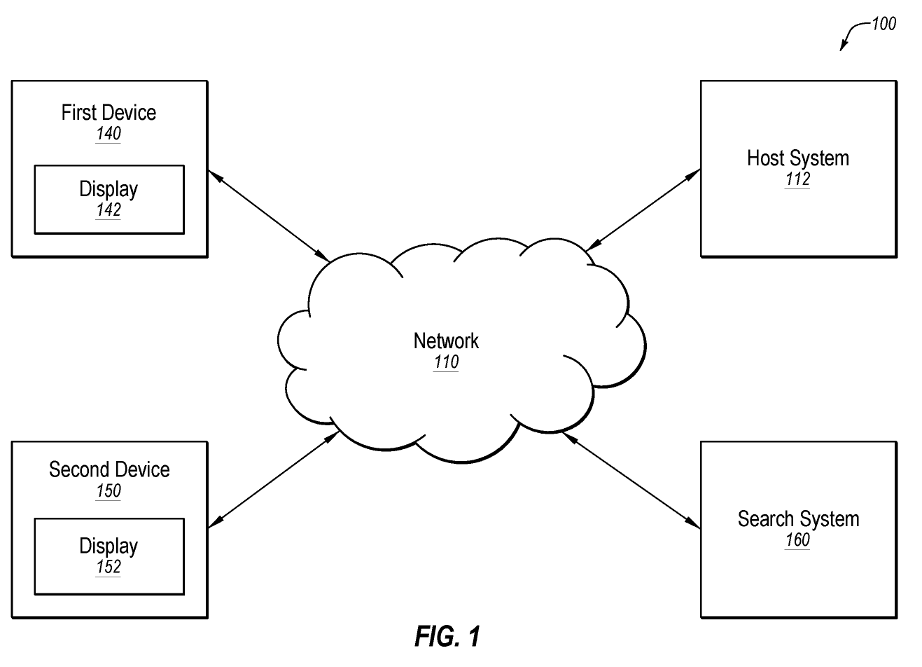

Turning to the figures, FIG. 1 illustrates an example system 100 that may be used for automated retrieval of product information. The system 100 may be arranged in accordance with at least one embodiment described in the present disclosure. The system 100 may include a network 110, a host system 112, a first device 140 that includes a display 142, a second device 150 that includes a display 152, and a search system 160.

The network 110 may be configured to communicatively couple the host system 112, the first device 140, the second device 150, and the search system 160. In some embodiments, the network 110 may be any network or configuration of networks configured to send and receive communications between devices. In some embodiments, the network 110 may include a conventional type network, a wired or wireless network, and may have numerous different configurations. Furthermore, the network 110 may include a local area network (LAN), a wide area network (WAN) (e.g., the Internet), or other interconnected data paths across which multiple devices and/or entities may communicate. In some embodiments, the network 110 may include a peer-to-peer network. The network 110 may also be coupled to or may include portions of a telecommunications network for sending data in a variety of different communication protocols. In some embodiments, the network 110 may include Bluetooth® communication networks or cellular communication networks for sending and receiving communications and/or data including via short message service (SMS), multimedia messaging service (MMS), hypertext transfer protocol (HTTP), direct data connection, wireless application protocol (WAP), e-mail, etc. The network 110 may also include a mobile data network that may include third-generation (3G), fourth-generation (4G), long-term evolution (LTE), long-term evolution advanced (LTE-A), Voice-over-LTE (“VoLTE”) or any other mobile data network or combination of mobile data networks. Further, the network 110 may include one or more IEEE 802.11 wireless networks.

The first device 140 may be any electronic device configured to provide a user with the ability to access information over a network. For example, the first device 140 may include a desktop computer, a laptop computer, a smartphone, a mobile phone, a tablet computer, or any other processing device configured to access information over a network.

In some embodiments, the first device 140 may be configured to receive input from a user and to present information to the user. For example, the first device 140 may be configured to execute computer-readable instructions to run a web browser. A user may interact with the web browser to cause the first device 140 to request and receive webpages from various servers that host various websites.

The first device 140 may further include a computer program that may be configured to extract information about a product from a webpage that is presented by the web browser in the display 142 of the first device 140. In these and other embodiments, the product may include a piece of merchandise or a service. For example, the product may include electronic equipment, clothing, food items, consumer products, commercial products, home goods, among any other products. Alternately or additionally, the product may be a service. Alternately or additionally, the product may be a combination of merchandise and a service, such as the purchase and installation of tires for a vehicle.

In some embodiments, the information extracted about the product may include an identifier of the product. The identifier of the product may include a stock keeping unit (SKU), a universal product code (UPC), an international article number (EAN), a global trade item number (GTIN), an Australian product number (APN), or some other identifier associated with merchandise or services. Alternately or additionally, the identifier of the product may include information that identifies a product. For example, the identifier of the product may include one or more of a manufacturer of the product, a name of the product, a configuration of the product, and other details of the product. The identifier of the product may be configured such that a search may be conducted for the same product from a different supplier, manufacture, retailer, or other entity that may sell products.

In some embodiments, the information extracted about the product may also include a value of a characteristic of the product. The characteristic of the product may include any detail regarding the manufacture or composition of the product or any information about the sale and delivery of the product.

For example, the characteristic of the product may include whether the product is a “green” product. A “green” product may be a product that is manufactured using material that is generally defined as environmentally friendly. For example, for electronics, the characteristic of the product may include an indication if the product is lead free certified. As another example, the characteristic of the product may include whether the product is manufactured by a company that is considered an environmentally friendly company or a company that is conscious about how, e.g., a labor force, using green manufacturing plants, and where products are manufactured, such as domestic or foreign manufacturing.

As another example, the characteristic of the product may include a sale price of the product. Alternately or additionally, the characteristic of the product may include a total price of the product including, shipping, sale, and tax or some combination thereof. Alternately or additionally, the characteristic of the product may include a shipping method, shipping time, or shipping costs. Alternately or additionally, the characteristic of the product may include rewards points or rebates associated with a purchase of the product. In some embodiments, the information extracted about the product may include values for multiple characteristics of the product.

After the computer program in the first device 140 extracts information about the product, the computer program may direct that the information about the product be transmitted over the network 110 to the host system 112. The information transmitted may include the identifier, the characteristic, and/or the value of the characteristic.

In some embodiments, the host system 112 may include any configuration of hardware, such as servers and databases that are networked together and configured to perform a task. For example, the host system 112 may include a single computing system that includes one or more processors and memory, such as a server or some other computing system configured to perform operations as described in this disclosure. Alternately or additionally, the host system 112 may include multiple computing systems, such as multiple servers, that are networked together and configured to perform operations as described in this disclosure.

The host system 112 may be configured to receive the information about the product from the first device 140. The information about the product from the first device 140 may be referred to herein as first information of the product. As such, the value of the characteristic in the information may be referred to as a first value and the webpage and the associated website may be referred to as a first webpage and first website.

In these and other embodiments, the host system 112 may be configured to direct a search to determine if the product is available from one or more second web sites. In some embodiments, the host system 112 may perform the search to determine if the product is available from one or more second websites. In these and other embodiments, the host system 112 may include a database or may be coupled with a database that may include information about products. For example, the database may include information about the availability of products from second websites. The database may be constructed by crawling the Internet to determine the availability of products from second websites.

In some embodiments, the database may include second values of the characteristic of the product from the second websites. Alternately or additionally, after determining the second web sites that include the product, the host system 112 may obtain second webpages from the second web sites that include the products. The host system 112 may parse the second webpages and extract the second values of the characteristic of the product.

In some embodiments, the host system 112 may transmit a request to the search system 160 through the network 110 to search for the second webpages that include the product. In these and other embodiments, the search system 160 may include a search engine, such as any common search engine. As directed by the host system 112, the search system 160 may search the internet for the second webpages that include the product and provide the second webpages. The host system 112 may obtain the second webpages directly from the search system 160. Alternately or additionally, the host system 112 may obtain links to the second webpages from the search system 160. Using the links, the host system 112 may request the second webpages from web servers, parse the second webpages, and extract the second values of the characteristic of the product.

In some embodiments, the host system 112 may access a database and may also request the search system 160 to perform a search for second webpages that include the product.

When the product is available from one or more second websites, the host system 112 may be configured to use information about the product from the second web sites to determine if any of the second values of the characteristic of the product meet a particular criterion.

The particular criterion may be based on the characteristic of the product and in some embodiments, on the first value of the characteristic of the product from the first webpage. For example, when the characteristic of the product is price, shipping costs, total costs, taxes, among others, the particular criterion may be that the second value is less than the first value. In these and other embodiments, the particular criterion may be determined based on the first value. In another example, when the characteristic of the product is shipping method, the particular criterion may be certified shipping that requires a signature over other shipping methods. As another example, the particular criterion may be that the manufacture is environmentally friendly.

In some embodiments, the host system 112 may determine the particular criterion based on information received from the first device 140. In these and other embodiments, the particular criterion may be determined by the host system 112 based on the first value provided by the first device 140 with the identifier of the product.

In some embodiments, the host system 112 may determine the particular criterion based on previous communications with the first device 140. In these and other embodiments, before the first device 140 parses the first webpage, the first device 140 may communication with the host system 112. The first device 140 may receive input from a user about user preferences with respect to the product. In these and other embodiments, the first device 140 may provide the user preferences with respect to the product to the host system 112. For example, before parsing the first webpage, the first device 140 may receive input from the user regarding the product. Alternately or additionally, the first device 140 may include stored preferences of the user that were previously obtained. The host system 112 may use the user preferences to determine the particular criterion.

In some embodiments, the user may have previously interacted with the host system 112 over the network 110 by way of the first device 140 or another device. In these and other embodiments, the user may be registered with the host system 112 and may have provided preferences to the host system 112. The host system 112 may use the stored user preferences to determine the particular criterion.

When the product is available from one or more second websites and the second values of the characteristic of the product meet the particular criterion, the host system 112 may direct the transmission of an indication to the second device 150 about the one or more second websites with products that include second values that meet the particular criterion. In some embodiments, the indication may include the multiple second websites that include products with second values that meet the particular criterion.

The second device 150 may be any electronic device configured to provide a user with the ability to access information over a network. For example, the second device 150 may include a desktop computer, a laptop computer, a smartphone, a mobile phone, a tablet computer, or any other processing device configured to access information over a network.

In some embodiments, the second device 150 may be configured to receive input from a user and to present information to the user. For example, the second device 150 may be configured to execute computer-readable instructions to run a software program. In some embodiments, the software program may be associated and in communication with the host system 112.

In these and other embodiments, the second device 150 may be configured to present a notification concerning the second values of the characteristic of the product through the software program. For example, the host system 112 may direct the transmission specifically to the software program on the second device 150. The software program may receive the indication about the one or more second websites with products that include second values that meet the particular criterion. The software program may generate the notification concerning the second values that meet the particular criterion. In these and other embodiments, the software program may present the notification on the display 152 of the second device 150.

In some embodiments, the notification may include links to the second websites that includes the product at the second values that meet the particular criterion. Alternately or additionally, the notification may include a presentation of one or more of the second webpages from the second web sites that present the product at the second values. Alternately or additionally, the notification may include links to webpages that include carts for purchasing the product from the second websites.

In some embodiments, the first device 140 and the second device 150 may both be associated with the same user. For example, a user may be viewing a webpage on the first device 140 that includes a product and may receive a notification about the second values of the characteristic of the product from the second device 150.

An example follows of the operation of the system 100. A user may interact with the first device 140 and cause the first device 140 to obtain a first webpage from a first website that includes a product. The first webpage may include a first price for the product. The first device 140 may parse the first webpage to obtain a UPC of the product and the first price of the product. The first device 140 may send the UPC and the first price to the host system 112.

The host system 112 may receive the UPC and the first price. The host system 112 may direct the search system 160 to perform a search for the product with the UPC. The search system 160 may perform the search and return an indication of second webpages that offer the product for sale. The host system 112 may parse the second webpages to obtain second prices for the product. The host system 112 may compare the second prices with the first price. The second webpages that include a second price lower than the first price may be selected by the host system 112 for indicating to the second device 150. The host system 112 may provide addresses of the second webpages, which include a second price lower than the first price, to the second device 150. The second device 150 may construct a notification to present to the user of the first device 140 that includes an indication of the second webpages and that the second webpages offer the product for sale at a price that is lower than the first price.

Note that the system 100 performs the operations to present the notification by the second device 150 without intervention of the user. The user may only navigate to the first webpage. At that point, based on no interaction or direction from the user, the system 100 may perform the operations described in this disclosure. As a result, in some embodiments, the operations may be completely automated. Furthermore, in some embodiments, the system 100 may perform the operations in a time frame such that the user is still being presented with the first webpage on the first device 140 when the notification is presented by the second device 150. Thus, the system 100 may present the user with an automated real-time shopping comparison of a product the user is viewing. This may have an effect to reduce comparison shopping time of the user and solves the problem resulting from the effect of numerous online retailers offering similar products that has arisen due to the internet.

Modifications, additions, or omissions may be made to the system 100 without departing from the scope of the present disclosure. For example, the host system 112 may include additional components and/or networks than those illustrated in or described with respect to FIG. 1. For example, the host system 112 may include additional databases, servers, and other computing systems configured to perform other tasks for the host system 112.

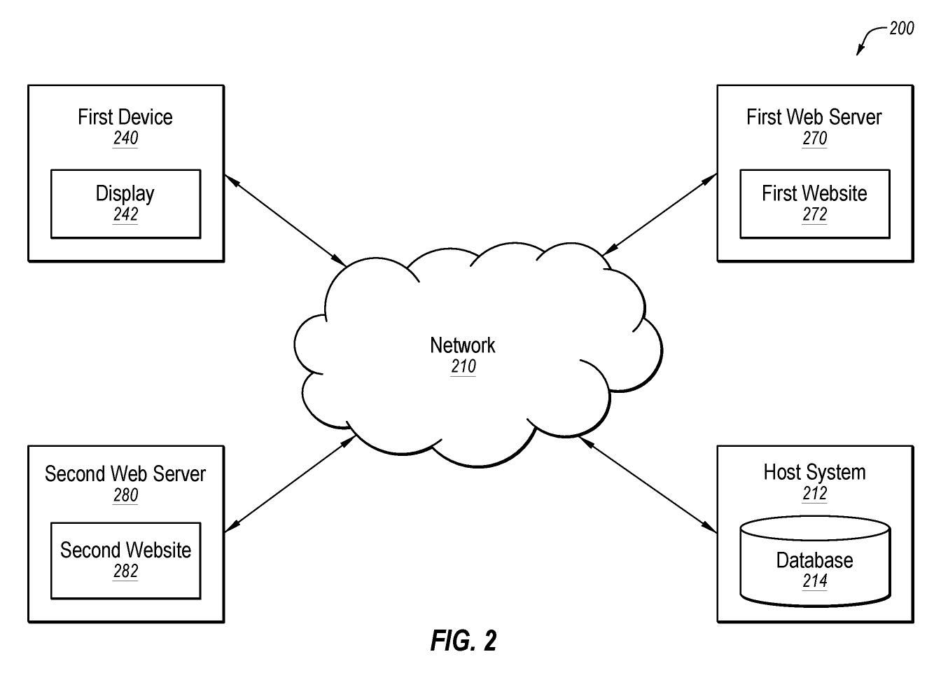

FIG. 2 illustrates another example system 200 that may be used for automated retrieval of product information. The system 200 may be arranged in accordance with at least one embodiment described in the present disclosure. The system 200 may include a network 210, a host system 212, a first device 240, a first web server 270, and a second web server 280.

The network 210 may be configured to communicatively couple the host system 22, the first device 340, the first web server 270, and the second web server 280. In some embodiments, the network 210 may be analogous to the network 110.

The first web server 270 may include any configuration of hardware, such as servers and databases that are networked together and configured to host a first website 272. The first website 272 may include multiple first webpages. One of the first webpages may present a product for sale, and may be referred in this disclosure as the first product webpage. Other of the first webpages of the first web site 272 may include links to the first product webpage. Alternately or additionally, other of the first webpages of the first web site 272 may include first cart and checkout webpages that allow a user to purchase the product or other products from the first web site 272.

The second web server 280 may include any configuration of hardware, such as servers and databases that are networked together and configured to host a second website 282. The second web server 280 may include multiple second webpages. One of the second webpages may present the product for sale, and may be referred in this disclosure as the second product webpage. Other of the second webpages of the second website 282 may include links to the second product webpage. Alternately or additionally, other the second webpages of the second website 282 may include second cart and checkout webpages that allow a user to purchase the product or other products from the second website 282.

The first device 240 may include any electronic device configured to provide a user with the ability to access information over a network. For example, the first device 240 may include a desktop computer, a laptop computer, a smartphone, a mobile phone, a tablet computer, or any other processing device configured to access information over a network.

In some embodiments, the first device 240 may be configured to receive input from a user and to present information to the user. For example, the first device 240 may be configured to execute computer-readable instructions to run a web browser. A user may interact with the web browser to cause the first device 240 to request and receive webpages from various servers that host various websites.

In some embodiments, the first device 240 may request a first webpage of the first website 272 from the first web server 270. The first web server 270 may provide the first webpage to the first device 240. The web browser operating on the first device 240 may present the first webpage to the user using the display 242.

In some embodiments, the first device 240 may further include a software program operating on the first device 240 that interfaces with the web browser. For example, the software program may be a plugin to the web browser. The software program may be configured to detect when a first webpage from the first web site 272 includes a product for sale.

In some embodiments, the software program may be configured to detect when a first webpage includes a product for sale based on the address of the first webpage. The address of the first webpage may include a uniform resource locator (URL). In these and other embodiments, the software program may be configured to parse the URL to look for one or more specific sequences of characters that indicates that the webpage includes a product for sale. For example, the software program may look for one or more of the following sequence of characters: /product/, /prod/, /products/, /p/, /itm/, /item/, /product.html, /product-detail/, /ip/, or /shop/, among other sequences of characters. These sequences of characters may indicate that the first webpage includes a product. More specifically, this sequence characters may indicate that the webpage is a webpage for a specific product. After detecting that the first webpage includes a product for sale, the software program may parse the first webpage.

In some embodiments, the software program may be configured to detect when a first webpage includes a cart with a product. In these and other embodiments, the software program may detect when the first webpage includes a cart or shopping cart. The software program may detect when the first webpage includes a cart or shopping cart by parsing the address of the first webpage to look for specific sequence of characters that indicates that the webpage includes a cart or shopping cart. For example, the software program may look for one or more of the following sequence of characters: cart, shoppingcart, or sc, among other sequences of characters.

Alternately or additionally, the software program may detect when the first webpage includes a cart or shopping cart by parsing a particular section of the source code of the first webpage. For example, the software program may parse the characters in the “title” section of the source code of the first webpage to detect a specific sequence of characters that indicates that the webpage includes a cart or shopping cart. For example, the software program may look for one or more of the following sequence of characters: cart, shopping cart, bag, among other sequences of characters.

After detecting that the first webpage may include a product, the software program may parse the source code of the first webpage to identify a product included in the first webpage. The identifier may be a name of a product along with a description of the product. Alternately or additionally, the identifier may be a stock keeping unit (SKU), a universal product code (UPC), an international article number (EAN), a global trade item number (GTIN), an Australian product number (APN), or some other identifier associated with a product.

The software program may also parse the source code to determine a value for a characteristic for the product. In these and other embodiments, the characteristic of the product may be selected by a user of the first device 240. For example, when the software program is first installed on the first device 240, the software program may receive information from the user regarding characteristics of product that are of interest to the user. Alternately or additionally, the software program may obtain information regarding a user's preference regarding characteristics of products from the host system 212 or from other systems. Alternately or additionally, the characteristic may be selected by the software program based on behavior patterns of the user when purchasing products. Alternately or additionally, the characteristic may be defaulted by the software program.

To parse the source code, the software program may look for particular markers in the source code related to the selected characteristic. For example, when the characteristic is price, the source code may parse the source code for a class, header, or other source code object that includes the characteristic. After identifying the relevant source code, the software program may analysis the relevant source code to determine the value of the characteristic. In some embodiments, the source code may include a link or indication that another webpage of the first web server 270 may include the first value. In these and other embodiments, the software program may request addition information from the first web server 270 to obtain the value of the characteristic.

After obtaining the identifier and the first value, the software program may direct transmission of the identifier and the first device 240 to the host system 212. In some embodiments, the software program may direct transmission of the characteristic to the host system 212 so as to provide the host system 212 with the characteristic. Alternately or additionally, the software program may not provide the characteristic to the host system 212. In these and other embodiments, the software program may have previously provided a characteristic that the host system 212 may use as a default characteristic or the host system 212 may have provided the characteristic to the software program such that the host system 212 has the characteristic.

The host system 212 may include any configuration of hardware, such as servers and databases that are networked together and configured to perform task. As illustrated in FIG. 2, the host system 212 may include a database 214. The database 214 may include websites that include the product and values for characteristics of the product.

The host system 212 may receive the identifier and the first value from the first device 240. The host system 212 may use the identifier to search the database 214 for other websites that include the product. The host system 212 may retrieve the data entries including the other websites and the values for the characteristics of the product.

The host system 212 may be further configured to determine a particular criterion for evaluating the characteristics of the product from the other websites based on the first value. For example, when the characteristic is price, the particular criterion may be that the prices of the product be less than the price of the product from the first website 272. As another example, when the characteristic is shipping methods, the particular criterion may be that the shipping methods of the product be different than the shipping method provided by the first website 272.

The host system 212 may analyze the other websites using the particular criterion. Based on the analysis of the other websites, the host system 212 may determine which of the other websites meet the particular criterion. The other websites that meet the particular criteria may be referred to as selected websites.

After determining the selected websites that meet the particular criteria, the host system 212 may provide an indication of the selected websites to the first device 240. In some embodiments, the host system 212 may provide an indication of all of the selected websites that meet the particular criterion to the first device 240. Alternately or additionally, the host system 212 may provide an indication of only one of the selected websites to the first device 240. In these and other embodiments, the host system 212 may select the one of the selected websites based on the particular criterion. For example, when the characteristic is price and the particular criterion is that the price for the selected websites be lower than the price offered by the first website 272, the host system 212 may select the selected website that includes the lowest price.

In some embodiments, the indication of the selected websites provided to the host system 212 may include an address of the selected websites. In particular, the host system 212 may provide addresses of webpages of the selected websites that includes the product and the characteristic of the product. In some embodiments, for each of the selected websites, the host system 212 may provide an identifier of the product that will be recognized by a user of the first device 240 and values of the characteristics of the product from the selected websites.

The first device 240 may receive the indication from the host system 212. In particular, the software program may receive the indication from the host system 212. In some embodiments, the software program may cause the web browser to adjust the presentation on the display 242. For example, the software program may cause a window inside the web browser to be presented that identifies the product, the values of the characteristics of the product from the selected websites, and addresses of the webpages from selected websites. In some embodiments, the window may partial overlay a current presentation of the web browser such that the current presentation of the web browser is partially obscured and partially visible. In these and other embodiments, the user may interact with the window to select the address of one or more of the selected websites to navigate to the webpages of the selected websites.

In some embodiments, the second website 282 may be one of the selected websites. In these and other embodiments, the software program on the first device 240 may receive the address of webpage of the second web site 282 and may request the webpage of the second website 282 from the second web server 280. The first device 240 may receive the source code of the webpage of the second website 282 and may present the webpage through the web browser on the display 242. In some embodiments, the software program may receive the source code of the webpage of the second website 282. In these and other embodiments, the software program may interact with the source code of the webpage to request that the second web server 280 provide another webpage of the second website 282. The other webpage may include the second cart and checkout webpages of the second website 282 that includes the product ready for purchase. In these and other embodiments, the software program may present an address of the purchasing webpage or may present the purchasing webpage in the display 242.

Modifications, additions, or omissions may be made to the system 200 without departing from the scope of the present disclosure. For example, the system 200 may include additional web servers. Alternately or additionally, the system 200 may include a search system analogous to the search system 160 of FIG. 1. In these and other embodiments, the host system 212 may not include the database 214 and may query the search system for the other websites. Alternately or additionally, the system 200 may include a second device similar to the second device 150 of FIG. 1.

Alternately or additionally, after the host system 212 receives the identifier and the first value from the first device 240, the host system 212 may use the identifier to search the database 214 for physical retail locations near the first device 240 that may offer the product for sale. In these and other embodiments, the database 214 may include information from the physical retail locations concerning their inventory and prices. The host system 212 may analyze the inventory from the physical retail locations using the particular criterion. Based on the analysis of the inventory, the host system 212 may determine which of the physical retail locations meet the particular criterion. The physical retail locations that meet the particular criteria may be referred to as selected physical retail locations.

After determining the selected physical retail locations that meet the particular criteria, the host system 212 may provide an indication of the selected physical retail locations to the first device 240. In some embodiments, the host system 212 may provide an indication of all of the selected physical retail locations that meet the particular criterion to the first device 240. Alternately or additionally, the host system 212 may provide an indication of only one of the selected physical retail locations to the first device 240. In these and other embodiments, the host system 212 may select the one of the selected physical retail locations based on the particular criterion. For example, when the characteristic is price and the particular criterion is that the price for the selected physical retail locations be lower than the price offered by the first website 272, the host system 212 may select the selected physical retail location that includes the lowest price.

The first device 240 may receive the indication from the host system 212. In particular, the software program may receive the indication from the host system 212. In some embodiments, the software program may cause the web browser to adjust the presentation on the display 242. For example, the software program may cause a window inside the web browser to be presented that identifies the product, the values of the characteristics of the product from the selected websites, and a name and a physical location of the selected physical retail locations.

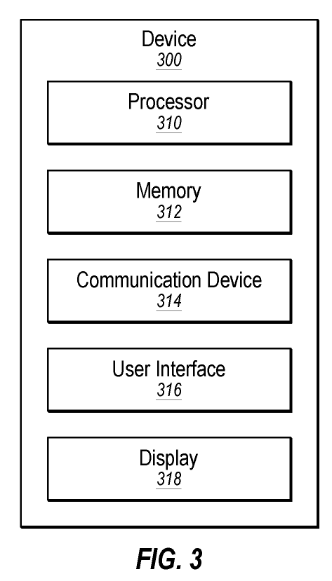

FIG. 3 illustrates an example device 300 that may be used in a system for automated retrieval of product information. The device 300 may be arranged in accordance with at least one embodiment described in the present disclosure. The device 300 may include a processor 310, a memory 312, a communication device 314, a user interface 316, and a display 318. In some embodiments, the device 300 may be an example of the first device 140, the second device 150, or the host system 112 of FIG. 1 or of the first device 240 or the host system 212 of FIG. 2.

In general, the processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, it is understood that the processor 310 may include any number of processors configured to perform individually or collectively any number of operations described herein. Additionally, one or more of the processors may be present on one or more different electronic devices, such as different servers. In some embodiments, the processor 310 may interpret and/or execute program instructions and/or process data stored in the memory 312. In some embodiments, the processor 310 may fetch program instructions and load the instructions in the memory 312. After the instructions are loaded into memory 312, the processor 310 may execute the program instructions to perform operations or methods described in this disclosure.

For example, the processor 310 may receive instructions, load the instructions into the memory 312, and execute the instructions to perform the operations described in this disclosure. For example, in some embodiments, the device 300 may be the first device 140 or 240 of FIGS. 1 and 2. In these and other embodiments, the processor 310 may execute instructions for a software program that may interact with a web browser to parse webpages and present notifications as described in this disclosure.

The memory 312 may include computer-readable storage media for carrying or having computer-executable instructions or data structures stored thereon. Such computer-readable storage media may be any available media that may be accessed by a general-purpose or special-purpose computer, such as the processor 310. By way of example, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication device 314 may include any component, device, system, or combination thereof that is configured to transmit or receive information over a network. In some embodiments, the communication device 314 may communicate with other devices at other locations, the same location, or even other components within the same system. For example, the communication device 314 may include a modem, a network card (wireless or wired), an infrared communication device, a wireless communication device (such as an antenna), and/or chipset (such as a Bluetooth device, an 802.6 device (e.g. Metropolitan Area Network (MAN)), a WiFi device, a WiMax device, cellular communication facilities, etc.), and/or the like. The communication device 314 may permit data to be exchanged with a network and/or any other devices described in the present disclosure.

The user interface 316 may include any component, device, system, or combination thereof that is configured to provide input from a user to the device 300. For example, the user interface 316 may include a mouse, a track pad, a touch screen, a keyboard, or any other device that may interface with the device 300 to provide user input to the device 300.

Modifications, additions, or omissions may be made to the device 300 without departing from the scope of the present disclosure. For example, the device 300 may include multiple other modules, units, or sub-systems than those discussed in this disclosure.

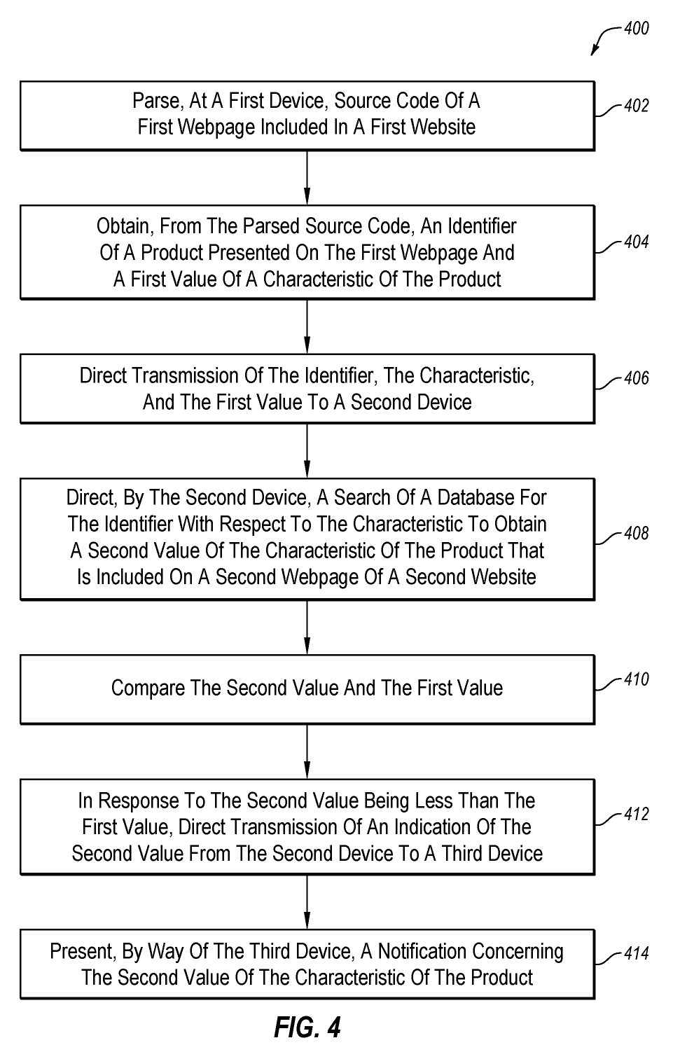

FIG. 4 is a flowchart of another example computer-implemented method 400 of automated product information retrieval. The method 400 may be arranged in accordance with at least one embodiment described in the present disclosure. The method 400 may be implemented, in some embodiments, by a system, such as the system 100 and/or 200 of FIGS. 1 and 2, respectively. Although illustrated as discrete blocks, various blocks may be divided into additional blocks, combined into fewer blocks, or eliminated, depending on the desired implementation.

The method 400 may begin at lock 402, where source code of a first webpage included in a first website may be parsed by a first device. In some embodiments, the first webpage may be parsed in response to the first webpage including a cart that includes the product. Alternately or additionally, the first webpage may be parsed in response to a user selection of a link on a third webpage of the first web site. In these and other embodiments, the link may include an address of the first webpage.

In block 404, an identifier of a product presented on the first webpage and a first value of a characteristic of the product may be obtained from the parsed source code. In some embodiments, the product may include merchandise or a service. In some embodiments, the characteristic of the product may include one or more of a sale price, a total price, a method of manufacture of the product, ingredients of the product, shipping options, among other characteristics.

In block 406, a transmission of the identifier, the characteristic, and the first value to a second device may be directed to be performed.

In block 408, a search of a database for the identifier with respect to the characteristic to obtain a second value of the characteristic of the product that is included on a second webpage of a second website may be directed to be performed by the second device.

In some embodiments, the search of the database may be conducted by the second device. Alternately or additionally, the second device may direct a separate computing system to perform the search of the database for the product. In these and other embodiments, the method 400 may further include receiving, from the separate computing system, search results from the search of the database and parsing the search results to obtain multiple third values of the characteristic of the product. The method 400 may further include selecting the second value of the characteristic from the multiple third values based on a particular criterion. In some embodiments, the second device may obtain the particular criterion from the first device.

In block 410, the second value and the first value may be compared. In block 412, in response to the second value being less than the first value, transmission of an indication of the second value from the second device to a third device may be directed to be performed. In some embodiments, in further response to the second value being less than the first value, transmission of an address of the second webpage may be directed to be performed. In these and other embodiments, the notification may further include a presentation of the second webpage that includes the second value of the characteristic of the product.

In block 414, a notification concerning the second value of the characteristic of the product may be presented by the third device. In some embodiments, the notification may further include a presentation of a third webpage of the second website. In these and other embodiments, the third webpage may include the product with the second value of the characteristic in a cart for purchase of the product.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

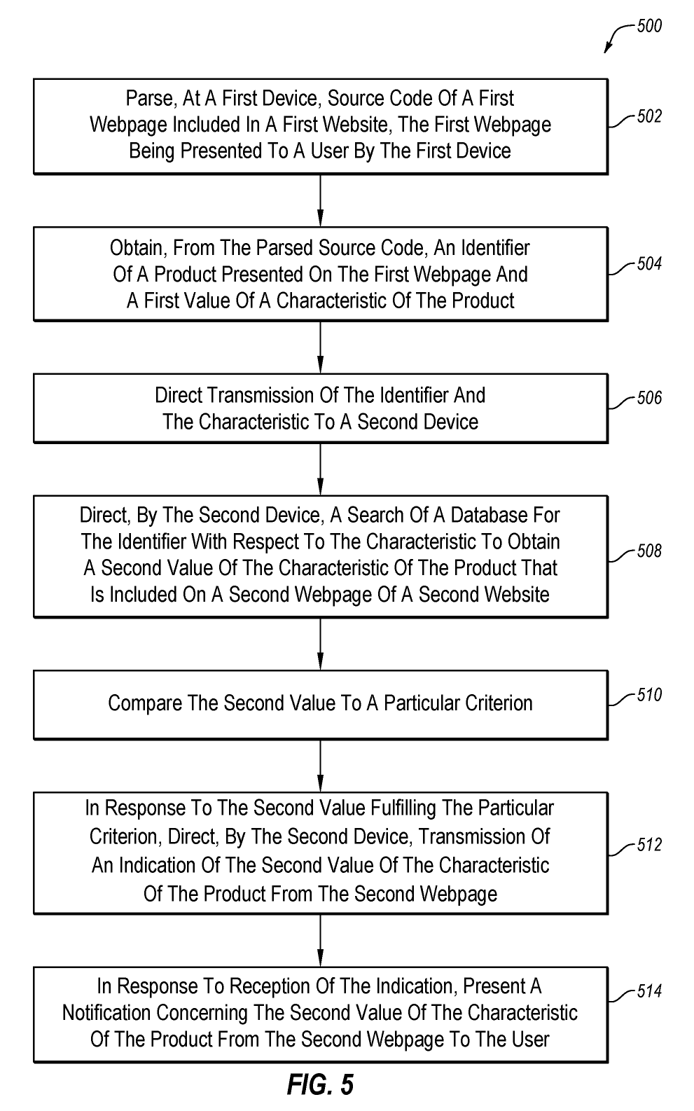

FIG. 5 is a flowchart of another example computer-implemented method 500 of automated product information retrieval. The method 500 may be arranged in accordance with at least one embodiment described in the present disclosure. The method 500 may be implemented, in some embodiments, by a system, such as the system 100 and/or 200 of FIGS. 1 and 2, respectively. Although illustrated as discrete blocks, various blocks may be divided into additional blocks, combined into fewer blocks, or eliminated, depending on the desired implementation.

The method 500 may begin at block 502, where source code of a first webpage included in a first website may be parsed at a first device. The first webpage may be presented to a user by the first device. In some embodiments, the first webpage may be parsed in response to the first webpage including a cart that includes the product. Alternately or additionally, the first webpage may be parsed in response to a user selection of a link on a third webpage of the first website. In these and other embodiments, the link may include an address of the first webpage.

In block 504, an identifier of a product presented on the first webpage and a first value of a characteristic of the product may be obtained from the parsed source code. In some embodiments, the product may include merchandise or a service. Alternately or additionally, the characteristic of the product may include one or more of a sale price, a total price, a method of manufacture of the product, ingredients of the product, shipping options, shipping prices, among other characteristics of the product.

In block 506, transmission of the identifier and the characteristic to a second device may be directed to be performed by the first device.

In block 508, a search of a database for the identifier with respect to the characteristic to obtain a second value of the characteristic of the product that is included on a second webpage of a second website may be directed to be performed by the second device.

In block 510, the second value and a particular criterion may be compared. In block 512, in response to the second value fulfilling the particular criterion, transmission of an indication of the second value of the characteristic of the product from the second webpage may be directed to be performed by the second device. In some embodiments, the second device may obtain the particular criterion from the first device.

In some embodiments, the transmission is directed to the first device. In these and other embodiments, the first device may be configured to present the notification concerning the second value of the characteristic of the product from the second webpage to the user.

In block 514, in response to reception of the indication, a notification concerning the second value of the characteristic of the product from the second webpage may be presented to the user.

One skilled in the art will appreciate that, for this and other processes, operations, and methods disclosed herein, the functions and/or operations performed may be implemented in differing order. Furthermore, the outlined functions and operations are only provided as examples, and some of the functions and operations may be optional, combined into fewer functions and operations, or expanded into additional functions and operations without detracting from the essence of the disclosed embodiments.

As indicated above, the embodiments described herein may include the use of a special purpose or general purpose computer (e.g., the processor 310 of FIG. 3) including various computer hardware or software modules, as discussed in greater detail below. Further, as indicated above, embodiments described herein may be implemented using computer-readable media (e.g., the memory 312) for carrying or having computer-executable instructions or data structures stored thereon.

In some embodiments, the different components, modules, engines, and services described herein may be implemented as objects or processes that execute on a computing system (e.g., as separate threads). While some of the system and methods described herein are generally described as being implemented in software (stored on and/or executed by general purpose hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc. are not necessarily used herein to connote a specific order. Generally, the terms “first,” “second,” “third,” etc., are used to distinguish between different elements. Absence a showing of a specific that the terms “first,” “second,” “third,” etc., connote a specific order, these terms should not be understood to connote a specific order.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A computer implemented method comprising:
parsing, at a first device, source code of a first webpage included in a first web site;
obtaining, from the parsed source code, an identifier of a product presented on the first webpage and a first value of a characteristic of the product;
directing transmission of the identifier and the first value to a second device;
directing, by the second device, a search of a database for the identifier with respect to the characteristic to obtain a second value of the characteristic of the product that is included on a second webpage of a second web site;
comparing the second value and the first value;
in response to the second value being less than the first value, directing transmission of an indication of the second value from the second device to a third device; and
presenting, by way of the third device, a notification concerning the second value of the characteristic of the product.

2. The computer implemented method of claim 1, wherein the search of the database is conducted by the second device.

3. The computer implemented method of claim 1, wherein the second device directs a separate computing system to perform the search of the database for the product, wherein the method further comprises:
receiving, from the separate computing system, search results from the search of the database;
parsing the search results to obtain a plurality of third values of the characteristic of the product; and
selecting the second value of the characteristic from the plurality of third values based on a particular criterion.

4. The computer implemented method of claim 3, wherein the second device obtains the particular criterion from the first device.

5. The computer implemented method of claim 1, wherein the first webpage is parsed in response to the first webpage including a cart that includes the product.

6. The computer implemented method of claim 1, wherein the first webpage is parsed in response to detection of a particular phrase in the address of the first webpage.

7. The computer implemented method of claim 1, wherein in further response to the second value being less than first value, directing transmission of an address of the second webpage, wherein the notification further include a presentation of the second webpage that includes the second value of the characteristic of the product.

8. The computer implemented method of claim 1, wherein the notification further includes a presentation of a third webpage of the second web site, the third webpage including the product with the second value of the characteristic in a cart for purchase of the product.

9. The computer implemented method of claim 1, wherein the product includes merchandise or a service.

10. The computer implemented method of claim 1, wherein the characteristic of the product includes one or more of a sale price, a total price, a method of manufacture of the product, ingredients of the product, shipping cost, and shipping options.

11. One or more non-transitory computer readable media that include computer instructions that when executed by one or more computing systems perform operations, the operations including a performance of the computer implemented method of claim 1.

12. A computer implemented method comprising:
parsing, at a first device, source code of a first webpage included in a first website, the first webpage being presented to a user by the first device;
obtaining, from the parsed source code, an identifier of a product presented on the first webpage and a first value of a characteristic of the product;
directing transmission of the identifier to a second device;
directing, by the second device, a search of a database for the identifier with respect to the characteristic to obtain a second value of the characteristic of the product that is included on a second webpage of a second web site;
comparing the second value to a particular criterion;
in response to the second value fulfilling the particular criterion, directing, by the second device, transmission of an indication of the second value of the characteristic of the product from the second webpage; and
in response to reception of the indication, presenting a notification concerning the second value of the characteristic of the product from the second webpage to the user.

13. The computer implemented method of claim 12, wherein the transmission is directed to a third device, the third device configured to present the notification concerning the second value of the characteristic of the product from the second webpage to the user.

14. The computer implemented method of claim 12, wherein the transmission is directed to the first device, the first device configured to present the notification concerning the second value of the characteristic of the product from the second webpage to the user.

15. The computer implemented method of claim 12, wherein the second device obtains the particular criterion from the first device.

16. The computer implemented method of claim 12, wherein the product includes merchandise or a service.

17. The computer implemented method of claim 12, wherein the characteristic of the product includes one or more of a sale price, a total price, a method of manufacture of the product, ingredients of the product, shipping price, and shipping options.

18. The computer implemented method of claim 12, wherein the first webpage is parsed in response to the first webpage including a cart that includes the product.

19. The computer implemented method of claim 12, wherein the first webpage is parsed in response to a keyword detected in the address of the first webpage.

20. One or more non-transitory computer readable media that include computer instructions that when executed by one or more computing systems perform operations, the operations including a performance of the computer implemented method of claim 12.
